(19) United States
(12) Patent Application Publication
(10) Pub. No.: US 2025/0328234 A1
(43) Pub. Date: Oct. 23, 2025

(54) Electronic Devices and Corresponding Methods for Transferring Application Operations Between Devices Using Swipe Gestures

(71) Applicant: Motorola Mobility LLC, Chicago, IL (US)

(72) Inventors: Amit Kumar Agrawal, Bangalore (IN); Brian Patrick Kennedy, Chicago, IL (US); Jing Li, Beijing (CN)

(21) Appl. No.: 18/657,513

(22) Filed: May 7, 2024

Related U.S. Application Data
(63) Continuation of application No. PCT/CN2024/088363, filed on Apr. 17, 2024.

(51) Int. Cl. G06F 3/0488; G06F 3/0484; G06F 9/451; H04M 1/72412

(52) U.S. Cl. CPC G06F 3/0488; G06F 3/0484; G06F 9/451; H04M 1/72412

(57) ABSTRACT

A method in an electronic device includes receiving, by a user interface, a swipe gesture identifying a companion electronic device operating within an environment of the electronic device. The method then transfers, by one or more processors using a communication device in response to the swipe gesture, operation of an application operating on the one or more processors to the companion electronic device identified by the swipe gesture.

### CROSS REFERENCE TO PRIOR APPLICATIONS

This application is a continuation claiming priority and benefit under 35 U.S.C. § 120, pursuant to 35 U.S.C. § 365(a), to PCT Application Ser. No. PCT/CN2024/088363, filed Apr. 17, 2024, which is incorporated by reference for all purposes. See MPEP § 1895.

### BACKGROUND

### Technical Field

This disclosure relates generally to electronic devices, and more particularly to electronic devices having wireless communication circuits.

### Background Art

Portable electronic devices are becoming smaller and smaller. A mobile phone configured only to make voice calls was the size of a shoebox not too long ago. Now, smartphones that can surf the web, maintain calendars, capture pictures and videos, send and receive text and multimedia messages, determine geographic location, and monitor health, in addition to making voice calls, slip easily into a pants pocket.

This evolution towards smallness is not entirely free of complication, however. As electronic devices get smaller, their user interfaces can be difficult to see. Text can become difficult to read due to small displays. Sounds can be difficult to hear due to small acoustic transducers, and so forth. It would be advantageous to have improved methods and systems that allow for small user interfaces without sacrificing a user's ability to consume content.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIGS. 1A-1D illustrate one or more method steps in accordance with one or more embodiments of the disclosure.

FIG. 2 illustrates one explanatory electronic device in accordance with one or more embodiments of the disclosure.

FIG. 3 illustrates one explanatory method in accordance with one or more embodiments of the disclosure.

FIG. 4 illustrates another explanatory method in accordance with one or more embodiments of the disclosure.

FIG. 5 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to transferring, by one or more processors of an electronic device in response to a user interface detecting a swipe gesture identifying a companion electronic device operating within an environment of an electronic device, operation of an application operating on the one or more processors to the companion electronic device identified by the swipe gesture. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of, in response to a user interface of an electronic device receiving an swipe gesture across a surface of the user interface defining a directional vector identifying a companion electronic device operating in an environment of the electronic device, causing a communication device of the electronic device to execute a transfer operation of a foreground application operating on the one or more processors to the companion electronic device as described herein. The non-processor circuits may include, but are not limited to, a radio receiver, a radio transmitter, signal drivers, clock circuits, power source circuits, and user input devices. As such, these functions may be interpreted as steps of a method to perform, in response to a user interface receiving a swipe gesture defining a directional vector extending from an electronic device to a companion electronic device operating in an environment or the electronic device, the transfer by one or more processors using a communication device of a foreground application of an application stack to a companion electronic device identified by the directional vector and thereafter, optionally, surfacing operation of a penultimate application of the application stack as a new foreground application.

Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure contemplate that mobile electronic communication devices are now used daily by billions of people. Users employ such devices many different purposes including, but not limited to, voice communications, text messaging, Internet browsing, calendar management, commerce such as banking, and social networking.

Embodiments of the disclosure also contemplate that as these devices have become more sophisticated, in some instances they have also become more complicated to operate. Illustrating by example, many “smart devices” now come equipped with touch sensitive displays rather than physical keyboards. While touching a surface is considered by some to be a simpler operation than working a complex keyboard, executing complex operations can require the navigation of several different menu tiers or user interface levels. Accordingly, embodiments of the disclosure contemplate that it would be advantageous to have simplified systems and methods for executing complex operations in modern electronic devices.

For instance, imagine that Amit has been listening to his favorite music streaming service on his smartphone to pass the time during his train ride to work. When he finally arrives at his desk, rather than continuing to deplete the battery of his smartphone, he would prefer to control the continuation of the Buster's Bluesman song to which he is listening, Chuck's Bone Gnawing Blues, from his computer. However, to do so, he must unlock his smartphone, navigate through several menus to find the music streaming application, navigate through more menus to find the settings and devices menu, and ultimately find the transfer icon to transfer control of the music streaming service from smartphone to computer. This can be tedious and time consuming. Indeed, in many cases Amit may see the task as so cumbersome that he avoids facing the navigation situation and instead causes the battery of his smartphone to just run out of blues driving juice.

Advantageously, embodiments of the disclosure provide a solution to this dilemma by providing Amit with a simple, intuitive, and quick way to transfer the operation of an application from a first electronic device to a second electronic device. In one or more embodiments, to transfer the operation of an application from a first device to a second device, all Amit needs to do is swipe his finger toward along the user interface of the transferring device toward the receiving device. In one or more embodiments, when this occurs, the foreground application operating on one or more processors of the transferring device transfers operation of that foreground application to the receiving device. Accordingly, the application instantly loads on the receiving device with media continuity. This allows Amit to save the energy in his smartphone battery without missing a single beat of Chuck's bone gnawing fun.

In one or more embodiments, a method in an electronic device comprises receiving, by a user interface of the electronic device, a swipe gesture identifying a companion electronic device operating within an environment of the electronic device. In one or more embodiments, in response to the swipe gesture, one or more processors transfer operation of an application operating on the one or more processors to the companion electronic device identified by the swipe gesture.

In one or more embodiments, the swipe gesture identifies the companion electronic device when a swipe direction of motion across the user interface occurs in a direction toward the companion electronic device. In one or more other embodiments, the swipe gesture identifies the companion electronic device when a swipe direction of motion across the user interface defines a directional vector extending from the electronic device to the companion electronic device.

Advantageously, when the companion electronic device comprises one electronic device of a plurality of electronic devices operating within the environment of the electronic device, this directional component of the swipe gesture can allow the one or more processors of the electronic device to identify to which companion electronic device operation of the application should be transferred.

For instance, when the one or more processors of the transferring electronic device determine a location of each companion electronic device of the plurality of companion electronic device within the environment relative to the electronic device, such as by using a ultra-wideband ranging process, a Bluetooth.sup.™ channel sounding process, or other process, the one or more processors can correlate a direction of movement of the swipe gesture across the user interface with locations of the plurality of companion electronic devices to identify the companion electronic device identified by the swipe gesture.

Since operation of the foreground application is being transferred to a companion electronic device in response to the swipe gesture, in one or more embodiments the one or more processors can then surface a penultimate application of an application stack as a new foreground application after the transfer. Thus, if Amit was listening to a music streaming service that was operating as a foreground application of an application stack, with an email application serving as the penultimate application of the application stack, in one or more embodiments the one or more processors can cause the email application to surface as the new foreground application after the music streaming service is transferred to the companion electronic device identified by the swipe gesture.

Advantageously, embodiments of the disclosure just make life easier. For instance, consider the situation where Amit is sitting at his desk with his smartphone lying flat on the desk next to his computer. Now imagine that there is a summary view of information being presented on the smartphone. With a single swipe gesture across the touch-sensitive display of the smartphone, Amit can transfer the presentation of the summary view of information to the computer to make it easier to interact with this information on the screen of his computer. Advantageously, he is able to do this without even picking up his smartphone!

In still other situations, embodiments of the disclosure can be used to perform “drag and drop” operations. For instance, imagine that over the weekend Amit took a lot of photos of a hiking trip that he took with his family. When putting together a slide show of the trip to share with a friend, in one or more embodiments Amit is able to use the directional swipe gesture to cause photos depicted on the display of his smartphone to slide over to a larger display that is visible to the friend. No longer does Amit need to download photos from a cloud application to the larger display device. Instead, he merely executes a swipe gesture to cause those photos to “magically fly” over to the display device.

In one or more embodiments an electronic device comprises a user interface, a communication device, and one or more processors that are operable with the user interface and the communication device. In one or more embodiments, the one or more processors, in response to the user interface receiving a swipe gesture across a surface of the user interface that defines a directional vector identifying a companion electronic device operating in an environment of the electronic device, cause the communication device to transfer operation of a foreground application operating on the one or more processors to the companion electronic device identified by the swipe gesture. In one or more embodiments, the one or more processors further cause the communication device to recall the operation of the foreground application from the companion electronic device in response to the user interface receiving another gesture input, one example of which is a reverse swipe gesture.

Embodiments of the disclosure even contemplate that users like Amit could benefit from a visual understanding of what is happening when a foreground application is being transferred to another electronic device identified by a swipe gesture. Accordingly, in one or more embodiments one or more processors of the electronic device transferring operation of the foreground application to the other electronic device cause an animation of a graphical user interface of the application to move on the user interface of the transferring electronic device along the directional vector defined by the swipe gesture while the communication device transfers operation of the foreground application to the other electronic device. Advantageously, this provides a visual indication to Amit that the foreground application is slipping the surly bounds of the transferring electronic device to touch the hand of the companion electronic device to which it is being transferred, to adapt a phrase.

Embodiments of the disclosure thus advantageously allow simplified, fast, and streamlined techniques for interacting with friends and family. To illustrating by example, imagine that Liz's fiancé, Dan, does not have a venue viewing application that Liz wants him to check out so they can confirm their wedding plans. In one or more embodiments, Liz is able to use a swipe gesture to transfer the content rendering application component of the venue viewing application to Dan's smartphone. Embodiments of the disclosure contemplate that the transfer of this rendering component can be independent of other components of the application. Thus, in one or more embodiments the content generating application component of the venue viewing application can remain operational on Liz's smartphone while the content rendering application component is transferred to Dan's smartphone.

In effect, the application's content generating (i.e., processor intensive) components are running on Liz's smartphone while the displaying components (which use less processing power) are running on Dan's smartphone. If the navigational application component remains operational on Liz's smartphone, this would allow Liz to interact with the content being rendered on Dan's smartphone. Dan, to his chagrin, may not be able to interact with the content, but can view Liz's interactions that will soon lead to their wedded bliss.

In other, more equitable situations, embodiments of the disclosure contemplate that the swipe gesture can lead to the transfer of a second instance of a foreground application from a first device to a second device. Illustrating by example, in other embodiments Liz may transfer an instance of a foreground application to Dan's smartphone so that they can both interact with the venue viewing application independently. In such a situation, embodiments of the disclosure contemplate that Liz's smartphone may be hosting two instances of the same application, with a content rendering application component and navigation application component of one instance being operational on Dan's smartphone.

In one or more embodiments, a method in an electronic device comprises receiving, by a user interface, a swipe gesture defining a directional vector extending from the electronic device to a companion electronic device operating in an environment of the electronic device. In one or more embodiments, in response to the swipe gesture, the method comprises causing, by one or more processors using a communication device, operation of a foreground application of an application stack to be transferred to the companion electronic device identified by the directional vector. Optionally, the one or more processors may then surface operation of a penultimate application of the application stack as a new foreground application after the transfer.

As noted above, the one or more processors may animate movement of a graphical user interface of the foreground application out of the application stack during the transfer to provide a visual indicator to the user that operation is being transferred from one electronic device to another. Other operations can be performed as well, including providing haptic feedback to a user when the transfer is complete, e.g., by vibrating the electronic device, by providing additional animations such as bubbling and expansion on the receiving device, and so forth. Still other additional operations will be obvious to those of ordinary skill in the art having the benefit of this disclosure.

Advantageously, embodiments of the disclosure provide electronic devices and corresponding methods that allow a user to effortlessly transition a mobile application from one smartphone to another. In one or more embodiments, this occurs with a continuity of media rendering with no stoppage or restarting of the application being transferred required. This advantageously allows a user to transfer applications from one device to another without any user experience “friction.” Moreover, it allows the user to maintain their experience immersion since the content keeps on playing with no need to pause, stop, or restart.

Other advantages offered by embodiments of the disclosure will be described below. Still others will be obvious to those of ordinary skill in the art having the benefit of this disclosure.

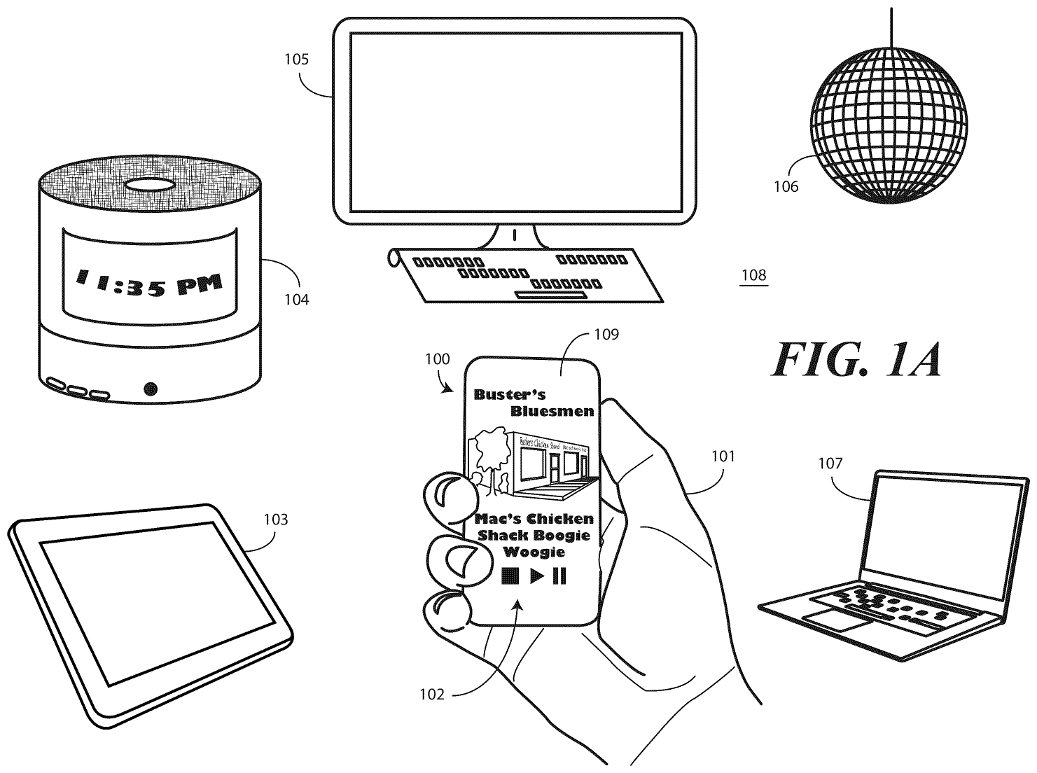

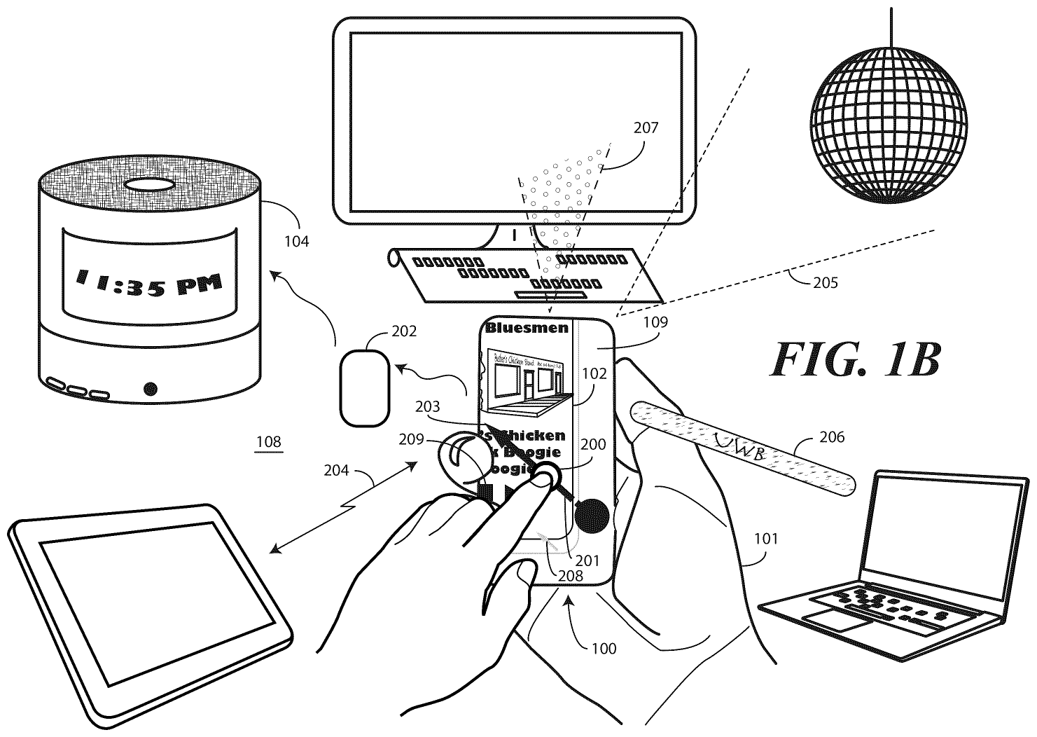

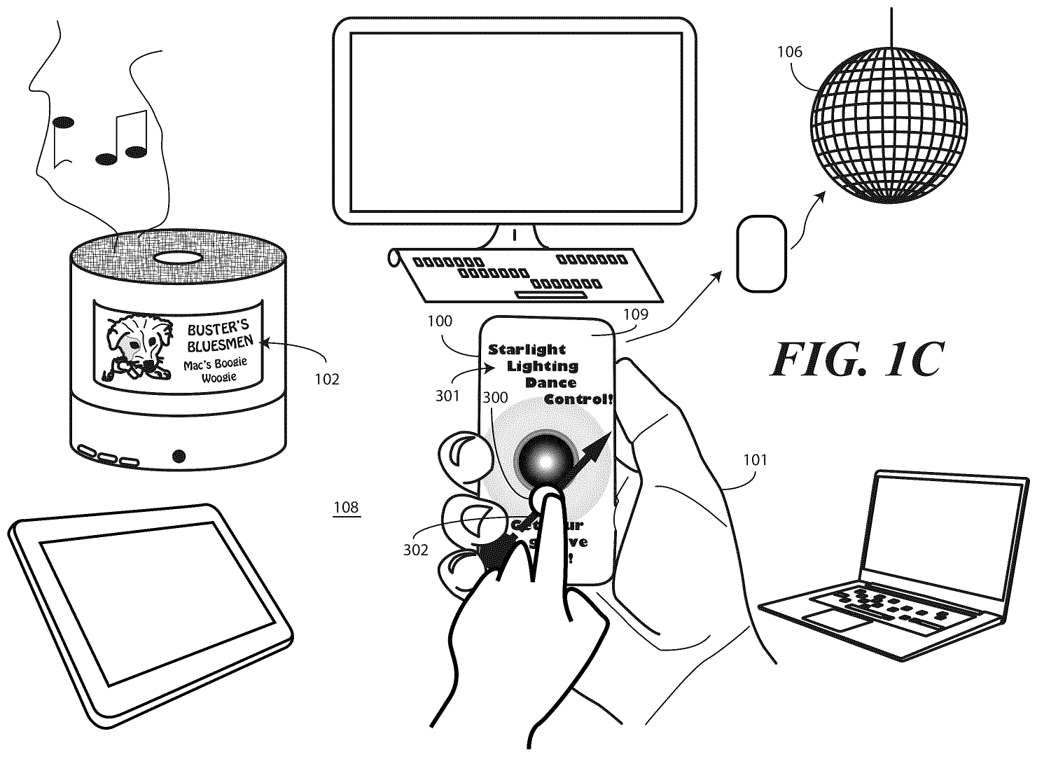

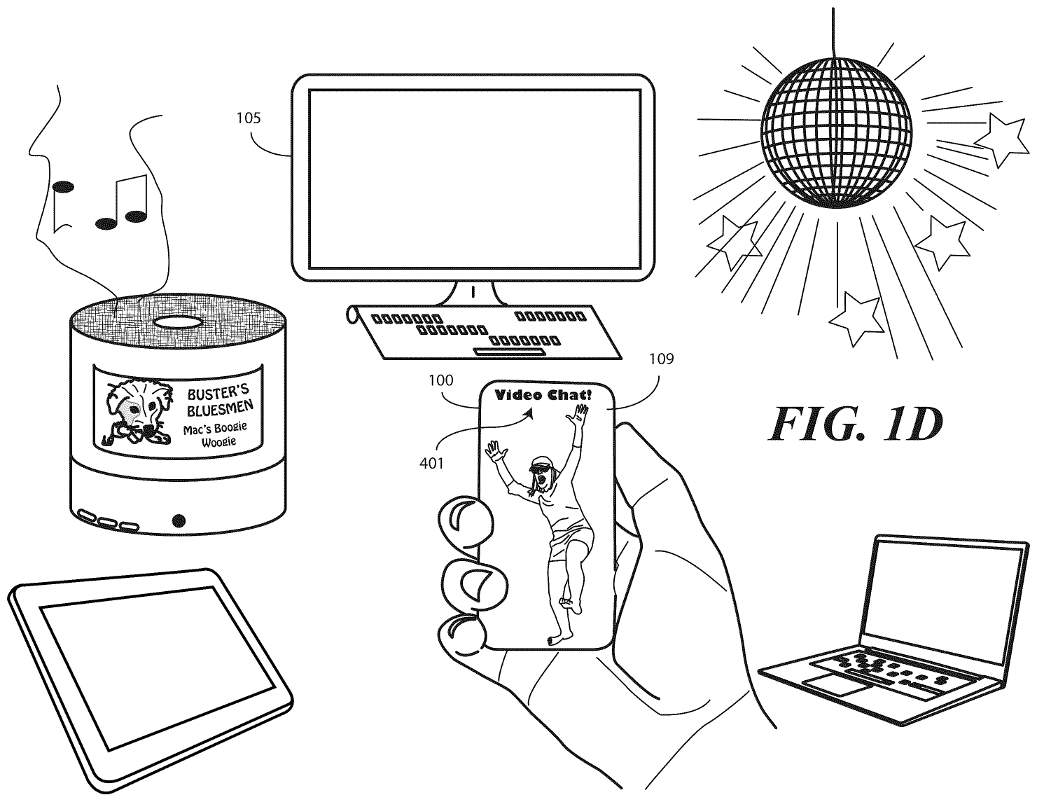

Turning now to FIG. 1A, illustrated therein is a user 101 using an electronic device 100 configured in accordance with one or more embodiments of the disclosure. As shown, a music player application 102 is operating as a foreground application in an application stack on the electronic device 100. To wit, the user 101 is listening to the iconic and legendary Buster and his Bluesmen play Mac's Chicken Shack Boogie Woogie.

While loving the reharmonizations of the basic blues form Buster employs, there are several companion electronic devices 103, 104, 105, 106, 107 operating within the environment 108 of the electronic device 100. These include companion electronic device 103, which is a tablet computer, companion electronic device 104, which is a music player, companion electronic device 105, which is a desktop computer, companion electronic device 106, which is a crazy disco ball, and companion electronic device 107, which is a laptop computer. Thus, companion electronic device 104, for example, would comprise one of a plurality of companion electronic devices 103, 104, 105, 106, 107 operating in the environment 108 of the electronic device 100.

The plurality of companion electronic devices 103, 104, 105, 106, 107 can communicate with the electronic device 100 in a variety of ways through a variety of networks and channels. Illustrating by example, in this illustrative embodiment companion device 104 is a music player that is paired with the electronic device 100 by a Bluetooth.sup.™ connection. Companion device 106, the crazy disco ball, is communicating with the electronic device 100 through a router in a Wi-Fi network. Companion electronic device 105 is a computer that is a trusted device paired with the electronic device 100 through a peer-to-peer ad hoc network. It should be noted that these devices and communication techniques merely provide some examples of companion devices for illustration. Others will be readily apparent to those of ordinary skill in the art having the benefit of this disclosure.

Some of these companion electronic devices 103, 104, 105, 106, 107 have better music rendering capabilities than the electronic device 100, while others are inferior to the electronic device 100. For instance, the music player has larger speakers with more powerful drivers than does electronic device 100, and thus is more suited for bringing out the sharp nines and flat thirteens of Buster's signature sound. By contrast, the crazy disco ball has no speakers and, despite having sophisticated electronics, would not do Buster justice in spreading the “blues gospel” he is laying down.

The user 101 in FIG. 1A does not want to interrupt the Mac's Chicken Shack Boogie Woogie-it is just too good a tune. In fact, you really do not listen Mac's Chicken Shack Boogie Woogie-you instead celebrate Mac's Chicken Shack Boogie Woogie. This celebration would be all the more enjoyable with better speakers. However, stopping Mac's Chicken Shack Boogie Woogie mid-tune would be no celebration indeed.

Fortunately, the electronic device 100 is configured in accordance with embodiments of the disclosure. This allows the user 101 to simply deliver a swipe gesture to the user interface 109 defined by the touch-sensitive display of the electronic device 100 to quickly and seamlessly transfer operation of the music player application from the electronic device 100 to another companion electronic device operating within the environment 108 that is identified by the swipe gesture.

In this illustrative example, the user 101 desires to send Mac's Chicken Shack Boogie Woogie to the companion electronic device 104 defined by the music player, as one would given the fact that the music player has better speakers with which to celebrate the music. Turning now to FIG. 1B, the user 101 does this by delivering a swipe gesture 200 to the user interface 109 of the electronic device 100. In one or more embodiments, the swipe gesture 200 defines a directional vector 201 identifying a companion electronic device 104 operating within the environment 108 of the electronic device 100. Thus, as shown in FIG. 1B one or more method steps include the user interface 109 receiving the swipe gesture 200 identifying the companion electronic device 104 operating within the environment 108 of the electronic device 100.

In one or more embodiments, one or more processors of the electronic device 100, using a communication device in response to the swipe gesture 200, transfer operation of an application 202 operating on the one or more processors of the electronic device 100 to the companion electronic device 104 identified by the swipe gesture 200. In one or more embodiments, this transfer of the application 202 occurs only when the swipe gesture 200 is received while the electronic device 100 is in an unlocked condition, as embodiments of the disclosure contemplate that for some electronic devices a swipe gesture delivered while the electronic device was locked would result in a “blind” swipe. While swipe gestures can be delivered to electronic devices having “always on” displays when in the locked condition in accordance with some embodiments, in other embodiments where content is not positioned on the display when the electronic device is locked a swipe gesture will not result in a transfer.

As shown in FIG. 1B, the swipe gesture 200 identifies the companion electronic device 104 when a swipe direction of motion 203 across the user interface 109 occurs in a direction toward the companion electronic device 104. In this particular example, the swipe gesture 200 identifies the companion electronic device 104 when the swipe direction of motion 203 across the graphical user interface 209 defines the directional vector 201 extending from the electronic device 100 to the companion electronic device 104.

In some embodiments, the one or more processors of the electronic device 100 can determine, via electronic communications 204, optical detection 205, an ultra-wideband ranging process 206 to determine distances, angle of arrival measurements, or azimuth angles, a Bluetooth.sup.™ sounding process 207, or by other techniques, the locations of each of the plurality of companion electronic devices 103, 104, 105, 106, 107. Using these or other techniques, the one or more processors of the electronic device 100 can determine the location of the plurality of companion electronic devices 103, 104, 105, 106, 107 within the environment 108 relative to the electronic device 100.

Based upon this locational knowledge and swipe direction of motion 203, in one or more embodiments the one or more processors of the electronic device 100 can correlate direction of movement of the swipe gesture 200 defined by the swipe direction of motion 203 across the user interface 109 with the locations of the plurality of companion electronic devices 103, 104, 105, 106, 107 to identify the companion electronic device, here companion electronic device 104, identified by swipe gesture 200. Once this is determined, transfer of the application 202 operating on the one or more processors of the electronic device 500 can be transferred to the companion electronic device 104. Said differently, in one or more embodiments the determination of the locations of the plurality of companion electronic devices 103, 104, 105, 106, 107 occurs before the transfer of the application 202.

Another beneficial feature offered by embodiments of the disclosure shown in FIG. 1B is a visual depiction to the user 101 of what is occurring. In this illustrative embodiment, the application 202 being transferred is the music player application 102 that was operating as a foreground application operating on an application stack. As will be shown in FIG. 1C, in one or more embodiments when the foreground application is transferred to the companion electronic device 104, the one or more processors of the electronic device 100 can surface a penultimate application of the application stack on the user interface 109 as a new foreground application.

Regardless of whether the music player application 102 is a foreground application on an application stack or a singular application operating on the one or more processors of the electronic device 100, in one or more embodiments to provide a visual cue that the application 202 is being transferred to the companion electronic device 104 the one or more processors cause an animation 208 of a graphical user interface 209 of the application 202 to move on the user interface 109 along the directional vector 201 while the communication device transfers the operation of the application operating on the one or more processors to the companion electronic device 104 identified by the swipe gesture 200. In this illustrative example, this makes the graphical user interface 209 look like its flying from the display of the electronic device 100 toward the companion electronic device 104 to which it is being transferred.

Turning now to FIG. 1C, operation of the music player application 102 has been fully transferred to companion electronic device 104. Since the music player application 102 was a foreground application of an application stack when operating on the electronic device 100, the one or more processors of the electronic device surface a penultimate application 301, which is a lighting control application for the crazy disco ball, to operate as a new foreground application on the application stack.

Once again, the user 101 desires to transfer the lighting control application to a companion electronic device 106, namely, the crazy disco ball. Accordingly, the user 101 delivers another swipe gesture 300 across a surface of the user interface 109 defining a directional vector 302 identifying companion electronic device 106, which is operating within the environment 108 of the electronic device 100. As previously described, this causes the communication device of the electronic device 100 to transfer operation of the lighting control application to the crazy disco ball identified by the swipe gesture 300.

Turning now to FIG. 1D, this transfer causes the crazy disco ball to be controlled by the lighting application, thereby emitting light and spinning. Since the lighting control application, prior to transfer, was the foreground application of the application stack in the electronic device 100, the one or more processors of the electronic device have again surfaced a penultimate application 401 from before the transfer to operate as a foreground application of the application stack after the transfer.

In this illustrative embodiment, the penultimate application 401 is a video chat application. Should the user 101 wish to transfer this penultimate application 401, shown now as the foreground application, to a device with a better display, e.g., companion electronic device 105, the user 101 could do this by delivering another swipe gesture defining a directional vector extending from the electronic device 100 to companion electronic device 105 while companion electronic device 105 is operating in the environment 108 of the electronic device 100. In response to the swipe gesture, the one or more processors of the electronic device 100 would then cause a communication device to transfer operation of this now foreground application of the application stack to the companion electronic device 105 identified by the directional vector. The one or more processors could then surface another penultimate application of the application stack as a new foreground application as previously described.

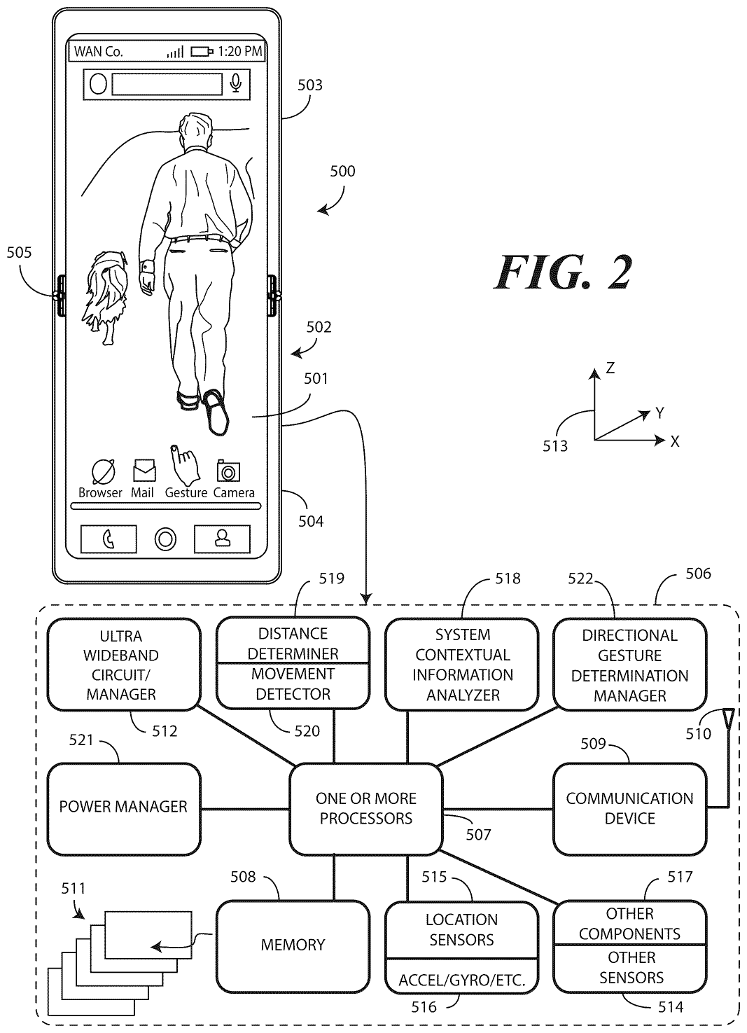

Turning now to FIG. 2, illustrated therein is one explanatory electronic device configured in accordance with one or more embodiments of the disclosure. The electronic device 500 of FIG. 2 is a portable electronic device and is shown as a smartphone for illustrative purposes. However, it should be obvious to those of ordinary skill in the art having the benefit of this disclosure that other electronic devices may be substituted for the explanatory smart phone of FIG. 2. For example, the electronic device 500 could equally be a conventional desktop computer, palm-top computer, a tablet computer, a gaming device, a media player, or other device.

This illustrative electronic device 500 includes a display 501, which may optionally be touch-sensitive. Users can deliver user input to the display 501, which serves as a user interface for the electronic device 500. In one embodiment, users can deliver user input to the display 501 of such an embodiment by delivering touch input from a finger, stylus, or other objects disposed proximately with the display 501. In one embodiment, the display 501 is configured as an active-matrix organic light emitting diode (AMOLED) display. However, it should be noted that other types of displays, including liquid crystal displays, would be obvious to those of ordinary skill in the art having the benefit of this disclosure.

The explanatory electronic device 500 of FIG. 2 also includes a device housing 502. In one embodiment, the device housing 502 includes two housing members, namely, a first device housing 503 that is coupled to a second device housing 504 by a hinge 505 such that the first device housing 503 is pivotable about the hinge 505 relative to the second device housing 504 between a closed position and an axially displaced open position. In other embodiments, such as that associated with the electronic device (100) of FIGS. 1A-1D, the device housing 502 will be rigid and will include no hinge.

In still other embodiments, the device housing 502 will be manufactured from a flexible material such that it can be bent and deformed. Where the device housing 502 is manufactured from a flexible material or where the device housing 502 includes a hinge, the display 501 can be manufactured on a flexible substrate such that it bends. In one or more embodiments, the display 501 is configured as a flexible display that is coupled to the first device housing 503 and the second device housing 504, spanning the hinge 505. Features can be incorporated into the device housing 502, including control devices, connectors, and so forth.

Also shown in FIG. 2 is an explanatory block diagram schematic 506 of the explanatory electronic device 500. In one or more embodiments, the block diagram schematic 506 is configured as a printed circuit board assembly disposed within the device housing 502 of the electronic device 500. Various components can be electrically coupled together by conductors, or a bus disposed along one or more printed circuit boards.

The illustrative block diagram schematic 506 of FIG. 2 includes many different components. Embodiments of the disclosure contemplate that the number and arrangement of such components can change depending on the particular application. Accordingly, electronic devices configured in accordance with embodiments of the disclosure can include some components that are not shown in FIG. 2, and other components that are shown may not be needed and can therefore be omitted.

In one embodiment, the electronic device includes one or more processors 507. In one embodiment, the one or more processors 507 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device. The application processor and the auxiliary processor(s) can be operable with the various components of the block diagram schematic 506. Each of the application processor and the auxiliary processor(s) can be configured to process and execute executable software code to perform the various functions of the electronic device with which the block diagram schematic 506 operates. A storage device, such as memory 508, can optionally store the executable software code used by the one or more processors 507 during operation.

In this illustrative embodiment, the block diagram schematic 506 also includes a communication device 509 that can be configured for wired or wireless communication with one or more other devices or networks. The networks can include a wide area network, a local area network, and/or personal area network. The communication device 509 may also utilize wireless technology for communication, such as, but are not limited to, peer-to-peer or ad hoc communications such as HomeRF, Bluetooth.sup.™. (suitable for performing the Bluetooth.sup.™ channel sounding process (207) described above with reference to FIG. 1B), IEEE 802.11, and other forms of wireless communication such as infrared technology. The communication device 509 can include wireless communication circuitry, one of a receiver, a transmitter, or transceiver, and one or more antennas 510.

In one embodiment, the one or more processors 507 can be responsible for performing the primary functions of the electronic device with which the block diagram schematic 506 is operational. For example, in one embodiment the one or more processors 507 comprise one or more circuits operable with the display 501 to present presentation information to a user. The executable software code used by the one or more processors 507 can be configured as one or more modules 511 that are operable with the one or more processors 507. Such modules 511 can store instructions, control algorithms, and so forth.

In one or more embodiments, the block diagram schematic 506 includes an ultra-wideband component 512, which is suitable for performing the ultra-wideband ranging process (206) described above with reference to FIG. 1B. In one or more embodiments, the ultra-wideband component 512 is similar to the communication device 509 in that it is configured to perform wireless communications with one or more other ultra-wideband components that may be integrated into, or attached to, other devices.

The illustrative ultra-wideband component 512 of FIG. 2 is a dedicated ultra-wideband transceiver constructed into the electronic device 500 configured to use the one or more antennas 510 or its own antenna structure to communicate, using ultra-wideband technology, with another ultra-wideband component situated in another electronic device, examples of which include the companion electronic devices (103, 104, 105, 106, 107) of FIGS. 1A-1D. In one or more embodiments, the ultra-wideband component 512 comprises wireless communication circuitry, one of a receiver, a transmitter, or transceiver, and one or more antennas, which may be separate from, or the same as, the one or more antennas 510 used by the communication device 509.

The inclusion of an ultra-wideband component 512 advantageously allows wireless communication with another ultra-wideband component connected to or integrated into another electronic device that is fast and secure, all while requiring very little power. In one or more embodiments, the ultra-wideband component 512 consumes at least an order of magnitude less energy than does the communication device 509. Ultra-wideband communication is especially well suited to embodiments of the disclosure because it is configured for short-range (within 250 meters) communication, which is well beyond the typical distance that will occur when an electronic device such as the electronic device 500 of FIG. 2 is operating within the environment (108) of FIGS. 1A-1D with the other companion electronic devices (103, 104, 105, 106, 107).

Additionally, the accuracy of location, and therefore the accuracy of distance measurements, is within a centimeter or less. While a Bluetooth.sup.™ channel sounding process can also be used to determine the location of companion electronic devices (103, 104, 105, 106, 107) operating within the environment (108), the use of an ultra-wideband ranging process (206) can be preferred because Bluetooth.sup.™ has an accuracy range of between one and five meters. Other location determination techniques, such as Wi-Fi, can be used as well but only have an accuracy of five to fifteen meters.

Ultra-wideband is also quite reliable, in that it offers strong immunity to multi-path communication channels and interference in the line of sight. It also offers exceptional bandwidth, with data communications occurring at up to 27 Mbps, which is in contrast to the 2 Mbps provided by Bluetooth.sup.™. Ultra-wideband is also very low latency, with typically latencies being less than a millisecond, which is in contrast to the several seconds of latency that can occur with Bluetooth.sup.™.

In one or more embodiments, the ultra-wideband component 512 can also be used to measure angle of arrival. Effectively, when the one or more antennas 510 are configured as an antenna array, the ultra-wideband component 512 can compare signals received from one side of the antenna array with other signals received from another side of the antenna array to determine an orientation of the electronic device 500 in three-dimensional space 513 relative to a content presentation companion device having another ultra-wideband component attached thereto or integrated therein.

Thus, angle of arrival measures the phase difference between two receive antennas of an antenna array to determine the amount of relative angle offset between the antenna array and a source of the signals. If two devices are situated normal to each other, then the angle of arrival would be either zero or very small. Additionally, this angle of arrival is independent of distance. The angle of arrival measurement is capable of measuring where the electronic device 500 is in relation to another electronic device from which phase differentiated signals are received in terms of elevation and azimuth as well.

To illustrate the independence of distance, if the electronic device 500 is situated normal to another electronic device with an angle of arrival that is zero, this angle of arrival remains zero when the electronic device 500 moves toward, or away from, the other electronic device (without rotating and staying on the same trajectory). It should be noted that an angle of arrival measurement can also measure how parallel the plane of the electronic device 500 and the ultra-wideband antenna array of the other electronic device are arranged (when on bore sight for the two antennas). Again, a zero angle of arrival would mean the two antenna arrays are perfectly parallel and perpendicular to each other. Again, in most situations angle of arrival is relatively independent of distance.

Various sensors 514 can be operable with the one or more processors 507. One example of a sensor that can be included with the various sensors 514 is a touch sensor. The touch sensor can include a capacitive touch sensor, an infrared touch sensor, resistive touch sensors, or another touch-sensitive technology. Capacitive touch-sensitive devices include a plurality of capacitive sensors, e.g., electrodes, which are disposed along a substrate. Each capacitive sensor is configured, in conjunction with associated control circuitry, e.g., the one or more processors 507, to detect an object in close proximity with-or touching-the surface of the display 501 or the device housing 502 of the electronic device 500 by establishing electric field lines between pairs of capacitive sensors and then detecting perturbations of those field lines.

Another example of a sensor that can be included with the various sensors 514 is a geo-locator that serves as a location detector 515. In one embodiment, location detector 515 is able to determine location data, both of the electronic device 500 itself and of companion electronic devices situated within an environment of the electronic device 500. In one or more embodiments. The location detector 515 determines the locations of companion electronic devices operating within an environment of the electronic device 500 from electronic communications from location detectors operating in those companion electronic devices via the communication device 509.

Location of the electronic device 500 can be determined by capturing the location data from a constellation of one or more earth orbiting satellites, or from a network of terrestrial base stations to determine an approximate location. The location detector 515 may also be able to determine location by locating or triangulating terrestrial base stations of a traditional cellular network, or from other local area networks, such as Wi-Fi networks.

Another example of a sensor that can be included with the various sensors 514 is an orientation detector 516 operable to determine an orientation and/or movement of the electronic device 500 in three-dimensional space 513. Illustrating by example, the orientation detector 516 can include an accelerometer, gyroscopes, or other device to detect device orientation and/or motion of the electronic device 500. Using an accelerometer as an example, an accelerometer can be included to detect motion of the electronic device. Additionally, the accelerometer can be used to sense some of the gestures of the user, such as one talking with their hands, running, or walking.

The orientation detector 516 can determine the spatial orientation of an electronic device 500 in three-dimensional space 513 by, for example, detecting a gravitational direction. In addition to, or instead of, an accelerometer, an electronic compass can be included to detect the spatial orientation of the electronic device 500 relative to the earth's magnetic field. Similarly, one or more gyroscopes can be included to detect rotational orientation of the electronic device 500.

Other components 517 operable with the one or more processors 507 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as a loudspeaker disposed behind a speaker port or other alarms and/or buzzers and/or a mechanical output component such as vibrating or motion-based mechanisms.

The other components 517 can also include proximity sensors, which can also be used to determine the location of companion electronic devices operating within an environment of the electronic device 500. The proximity sensors generally fall in to one of two camps: active proximity sensors and “passive” proximity sensors. Either the proximity detector components or the proximity sensor components can be generally used for gesture control and other user interface protocols.

The other components 517 can optionally include a barometer operable to sense changes in air pressure due to elevation changes or differing pressures of the electronic device 500. The other components 517 can also optionally include a light sensor that detects changes in optical intensity, color, light, or shadow in the environment of an electronic device. This can be used to make inferences about context such as weather or colors, walls, fields, and so forth, or other cues. An infrared sensor can be used in conjunction with, or in place of, the light sensor. The infrared sensor can be configured to detect thermal emissions from an environment about the electronic device 500. Similarly, a temperature sensor can be configured to monitor temperature about an electronic device.

A context engine 518 can then be operable with the various sensors to detect, infer, capture, and otherwise determine persons and actions that are occurring in an environment about the electronic device 500. For example, where included one embodiment of the context engine 518 determines assessed contexts and frameworks using adjustable algorithms of context assessment employing information, data, and events.

These assessments may be learned through repetitive data analysis. Alternatively, a user may employ a menu or user controls via the display 501 to enter various parameters, constructs, rules, and/or paradigms that instruct or otherwise guide the context engine 518 in detecting multi-modal social cues, emotional states, moods, and other contextual information. The context engine 518 can comprise an artificial neural network or other similar technology in one or more embodiments.

In one or more embodiments, the electronic device 500 includes a distance determination manager 519 that is operable with the ultra-wideband component 512 to determine a precise distance (within one centimeter) of the electronic device 500 in relation to other electronic devices also having ultra-wideband components or ultra-wideband tags (the difference between a ultra-wideband component and a ultra-wideband tag is that the ultra-wideband component is integrated into an electronic device as an original component, while a ultra-wideband tag is a self-contained ultra-wideband component that can be attached to an electronic device as a retrofit item to configure a legacy electronic device to communicate via ultra-wideband technology).

A motion detector 520 determines when the electronic device 500 moves. A power manager 521 can be configured to ensure that distance measurements, ultra-wideband communications, Bluetooth.sup.™ communications, user interactions such as the receipt of swipe gestures and their directional vectors, and other operations are optimally performed with minimal power expenditures.

In one or more embodiments, the electronic device 500 includes a directional gesture determination manager 522. In one or more embodiments, the directional gesture determination manager 522 is configured, in response to a user interface such as the display 501 receiving a swipe gesture defining a directional vector extending form the electronic device 500 to a companion electronic device operating in an environment of the electronic device 500, identify the companion electronic device to which the directional vector is directed. In response to the swipe gesture and the directional gesture determination manager 522 identifying the companion electronic device, the communication device 509 can, in response to the one or more processors 507, transfer the operation of a foreground application of an application stack to a companion electronic device identified by the directional vector.

The one or more processors 507 can also surface the operation of a penultimate application of the application stack as a new foreground application after the transfer, as previously described. The directional gesture determination manager 522 can use any of the locational and directional techniques described above with reference to FIGS. 1A-1D.

The electronic device 500 can also include a distance determiner 519 that is operable with the directional gesture determination manager 522, the communication device 509, and/or the ultra-wideband component 512. Illustrating by example, in one or more embodiments the ultra-wideband component 512, using ultra-wideband ranging process, delivers signals to the distance determination manager 519. The distance determination manager 519 can then use distance to identify a companion electronic device, as it is unlikely that every companion electronic device of the plurality of companion electronic devices operating within the environment will be the same distance from the electronic device 500. When combined with the directional vector determined by the directional gesture determination manager 522, the location of each companion electronic device operating within the environment of the electronic device 500 can be determined with precision.

In one or more embodiments, motion detectors 520 carried by the electronic device 500 can determine when the electronic device 500 moves relative to the various companion electronic devices operating within the environment. When this occurs, the directional gesture determination manager 522 and/or the distance determiner 519 can repeat their calculations to ensure that the locations of the companion electronic devices operating in the environment is continuously known to the one or more processors 507 despite the electronic device 500 moving around within that environment.

In one or more embodiments, the ultra-wideband component 512 can also perform an ultra-wideband angle of arrival measurement to determine an orientation of the electronic device 500 in three-dimensional space 513 relative to the content presentation companion device. Illustrating by example, the ultra-wideband angle of arrival measurement can be used to determine whether a person holding an electronic device 500, while delivering a swipe gesture to the display 501, is facing a particular companion electronic device or is facing away from a particular companion electronic device.

In one or more embodiments, the context engine 518, directional gesture determination manager 522, and distance determiner 519 are operable with the one or more processors 507. In some embodiments, the one or more processors 507 can control the context engine 518, directional gesture determination manager 522, and distance determiner 519. In other embodiments, the context engine 518, directional gesture determination manager 522, and distance determiner 519 can each operate independently from the one or more processors 507. The context engine 518, directional gesture determination manager 522, and distance determiner 519 can each receive data from the various sensors 514. In one or more embodiments, the one or more processors 507 are configured to perform the operations of the context engine 518, directional gesture determination manager 522, and distance determiner 519.

It is to be understood that FIG. 2 is provided for illustrative purposes only and for illustrating components of one electronic device 500 in accordance with embodiments of the disclosure and is not intended to be a complete schematic diagram of the various components required for an electronic device. Therefore, other electronic devices in accordance with embodiments of the disclosure may include various other components not shown in FIG. 2 or may include a combination of two or more components or a division of a particular component into two or more separate components, and still be within the scope of the present disclosure. In other embodiments, these support plates will be omitted.

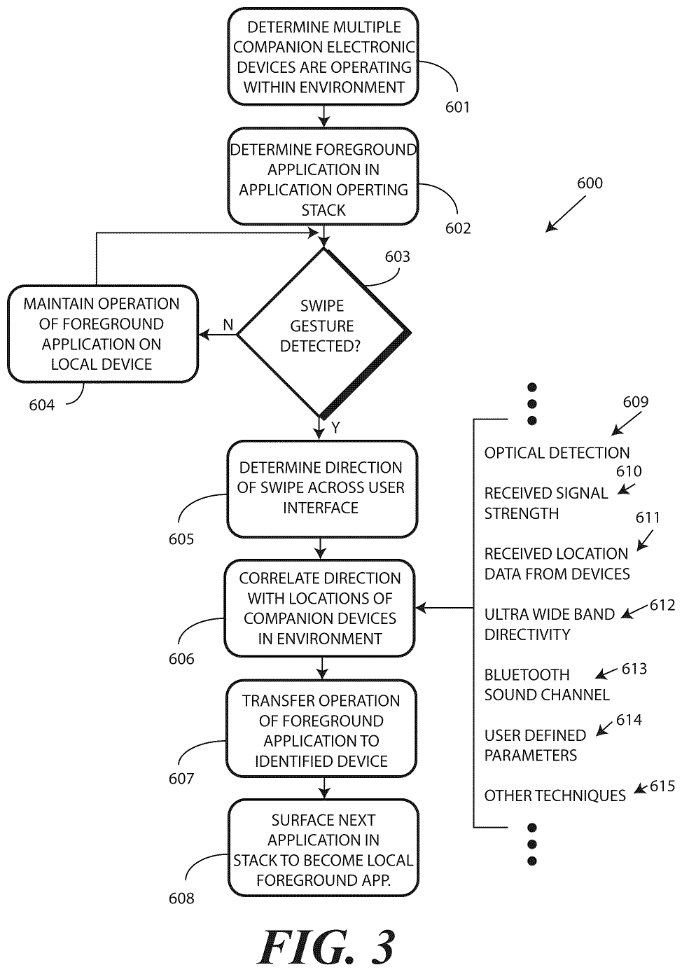

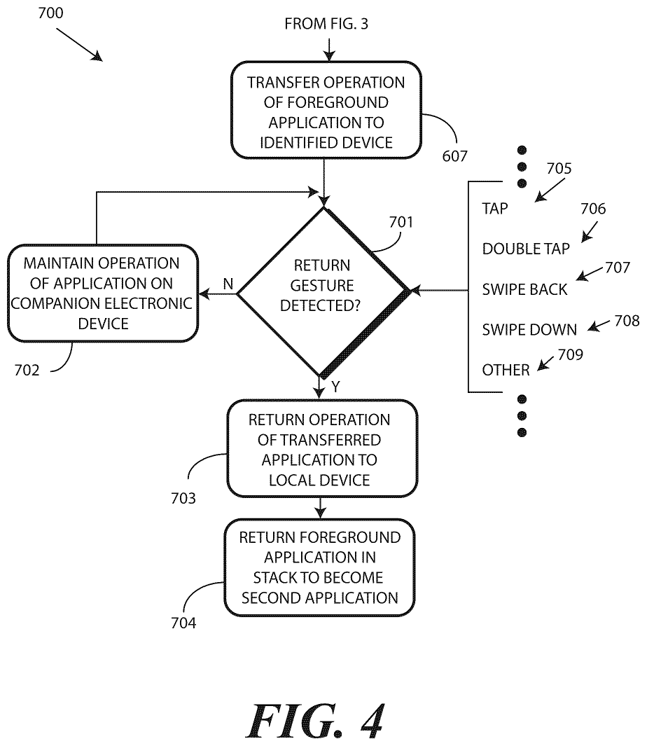

Turning now to FIG. 3, illustrated therein is one explanatory method 600 for an electronic device. The method 600 of FIG. 3 is suitable for use in the electronic device (500) of FIG. 2, the electronic device (100) of FIGS. 1A-1D, or another electronic device.

Beginning at step 601, one or more processors of an electronic device determine that multiple companion electronic devices are operating within an environment of the electronic device. This can be done in a variety of ways, including by detecting electronic communications received from the companion electronic devices via peer-to-peer, Wi-Fi, cellular, or other networks. Additionally, an ultra-wideband component, proximity censors, image capture devices via image analysis, or other sensors of the electronic device can detect that a plurality of companion electronic devices are operating in the environment of the electronic device as well. In one or more embodiments, step 601 determines the locations of each companion electronic device as well, as described above.

At step 602, one or more processors of the electronic device identify a foreground application operating on the one or more processors. In one or more embodiments, this foreground application will be the foreground application of an application stack.

Decision 603 determines whether a swipe gesture is received by a user interface of the electronic device. In one or more embodiments, decision 603 determines whether a swipe gesture defining a directional vector extending from the electronic device of a companion electronic device operating within the environment of the electronic device. Where it does, step 605 determines a direction of the swipe gesture from the directional vector. Otherwise, step 604 maintains operation of the foreground application on the one or more processors of the electronic device.

Step 606 then correlate a direction of movement of the swipe gesture across the user interface with locations of the plurality of companion electronic devices to identify the companion electronic device identified by the swipe gesture. This can occur in a variety of ways, many of which have been described above.

Illustrating by example, in one or more embodiments an image capture device employs optical detection 609 using image analysis to determine the locations of each companion electronic device. Similarly, a communication device of the electronic device can use received signal strength measurements 610 to determine locations of the various companion electronic devices.

In some embodiments, each companion electronic device will transmit its location data 611 to alert the one or more processors of the electronic device as to where each companion electronic device is situated in three-dimensional space. By comparing this location data 611 to the location data of the electronic device determined by its own location detector, precise locations of each companion electronic device can be determined.

In other embodiments, an ultra-wideband ranging process 612 can determine the location of each companion electronic device with precision as described above. Similarly, Bluetooth.sup.™ channel sounding 613 can be used. In some simpler embodiments, a user can simply enter the locations of the companion electronic devices with user input 614 delivered to the user interface. Other techniques 615 for determining the location of the various companion electronic devices will be obvious to those of ordinary skill in the art having the benefit of this disclosure.

In response to the swipe gesture, step 607 transfers the foreground application to the companion electronic device identified by the direction of motion determined at step 605 and/or the directional vector determined at decision 603. This transfer occurring at step 607 can vary.

Illustrating by example, in a situation where a user is sitting at his desk with his smartphone lying flat on the desk next to his computer, step 607 can transfer the foreground application to the computer to make it easier to interact with this information on the screen of his computer. This would be a complete transfer of the foreground application to the companion electronic device. However, other types of transfers can occur at step 607 in other embodiments.

For instance, the transfer occurring at step 607 can perform “drag and drop” operations. In one or more embodiments, a user may deliver a directional swipe gesture to cause, for example, photos depicted on the display of his smartphone to slide over to a larger display that is visible to the friend. This transfers content output by the application to the companion electronic device without transferring underlying operational control of the application to the companion electronic device.

In still other embodiments, a user can use a swipe gesture to transfer the content rendering application component to a companion electronic device. Embodiments of the disclosure contemplate that the transfer of this rendering component can be independent of other components of the application. Thus, in one or more embodiments the content generating application component of the venue viewing application can remain operational on the electronic device while the content rendering application component is transferred to the companion electronic device.

In effect, the application's content generating (i.e., processor intensive) components are running on the electronic device while the displaying components (which use less processing power) are running on the companion electronic device. Of course, the opposite transfer could occur to offload processor-intensive components of an application as well.

In other, more equitable situations, embodiments of the disclosure contemplate that the swipe gesture can lead to the transfer of a second instance of a foreground application from a first device to a second device at step 607. Illustrating by example, in other embodiments the electronic device may transfer an instance of a foreground application to a companion electronic device so that multiple users can both interact with the application independently. In such a situation, embodiments of the disclosure contemplate that the electronic device may be hosting two instances of the same application, with a content rendering application component and navigation application component of one instance being operational on a companion electronic device.

In one or more embodiments, step 607 comprises causing, by one or more processors using a communication device, operation of a foreground application of an application stack to be transferred to the companion electronic device identified by the directional vector. As noted above, step 607 may optionally animate movement of a graphical user interface of the foreground application out of the application stack during the transfer to provide a visual indicator to the user that operation is being transferred from one electronic device to another. Other operations can be performed as well at step 607, including providing haptic feedback to a user when the transfer is complete, e.g., by vibrating the electronic device, by providing additional animations such as bubbling and expansion on the receiving device, and so forth. Still other additional operations will be obvious to those of ordinary skill in the art having the benefit of this disclosure.

Optionally, step 608 can then surface operation of a penultimate application of the application stack as a new foreground application after the transfer. Advantageously, the method 600 of FIG. 3 provides electronic devices and corresponding methods that allow a user to effortlessly transition a mobile application from one smartphone to another. In one or more embodiments, this occurs with a continuity of media rendering with no stoppage or restarting of the application being transferred required. This advantageously allows a user to transfer applications from one device to another without any user experience “friction.” Moreover, it allows the user to maintain their experience immersion since the content keeps on playing with no need to pause, stop, or restart.

While the method 600 of FIG. 3 transfers an application, embodiments of the disclosure also contemplate that a user may desire to recall the application to the electronic device at a later time. Turning now to FIG. 4, illustrated therein is one explanatory method 700 for doing so. Others will be obvious to those of ordinary skill in the art having the benefit of this disclosure.

The method 700 begins with step 607, where one or more processors transfer, using a communication device in response to a swipe gesture identifying a companion electronic device operating within an environment of the electronic device, operation of an application operating on the one or more processors to the communication device identified by the swipe gesture. Decision 701 then determines whether a predefined gesture requesting return of the operation of the application is desired.

The predefined gesture detected at decision 701 can vary. In one or more embodiments, the predefined gesture comprises a tap gesture 705 on the user interface of the electronic device. In other embodiments, the predefined gesture comprises a double-tap gesture 706.

In still other embodiments, the predefined gesture identifies the companion electronic device from which the operation of the application should be withdrawn. Illustrating by example, the predefined gesture comprises a reverse swipe gesture 707 defining a reverse directional vector identifying the companion electronic device. In other embodiments, a more generic swipe down gesture 708 will function as a recall gesture. Other examples 709 will be obvious to those of ordinary skill in the art having the benefit of this disclosure.

At step 703, the method 700 recalls the operation of the application from the companion electronic device. In one or more embodiments, step 703 also resumes the operation of the application on the one or more processors of the electronic device. Where the application was one application of an application stack, step 704 can return the application to be the foreground application of the application stack, relegating the previous foreground application to become a penultimate application.

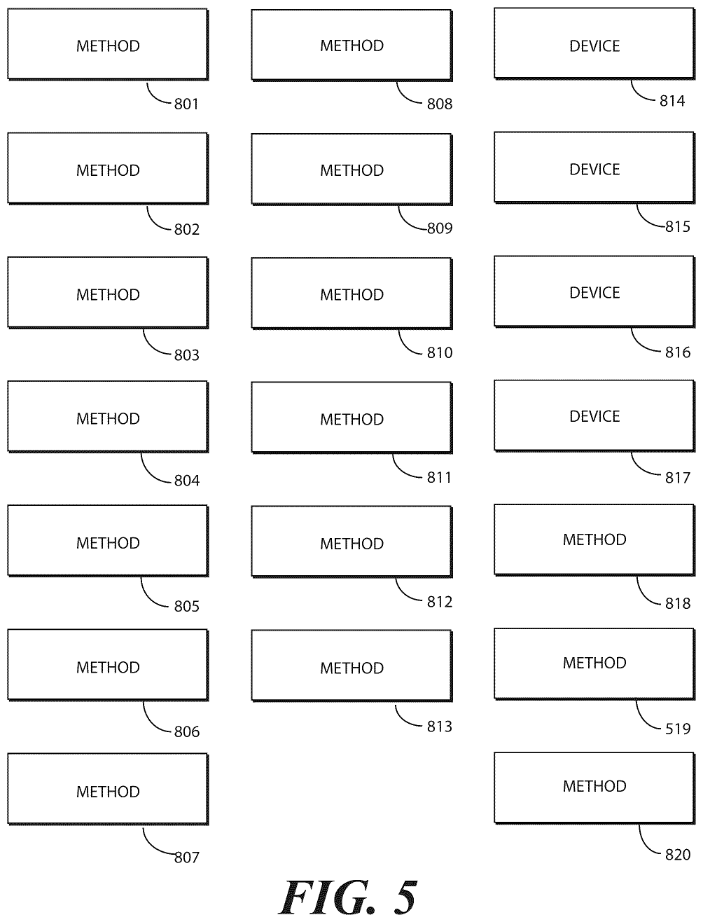

Turning now to FIG. 5, illustrated therein are various embodiments of the disclosure. The embodiments of FIG. 5 are shown as labeled boxes in FIG. 5 due to the fact that the individual components of these embodiments have been illustrated in detail in FIGS. 1A-1D and 2-4, which precede FIG. 5. Accordingly, since these items have previously been illustrated and described, their repeated illustration is no longer essential for a proper understanding of these embodiments. Thus, the embodiments are shown as labeled boxes.

At 801, a method in an electronic device comprises receiving, by a user interface, a swipe gesture identifying a companion electronic device operating within an environment of the electronic device. At 801, the method comprises transferring, by one or more processors using a communication device in response to the swipe gesture, operation of an application operating on the one or more processors to the companion electronic device identified by the swipe gesture.

At 802, the swipe gesture of 801 identifies the companion electronic device when a swipe direction of motion across the user interface occurs in a direction toward the companion electronic device. At 803, the swipe gesture of 801 identifies the companion electronic device when a swipe direction of motion across the user interface defines a directional vector extending from the electronic device to the companion electronic device.

At 804, the companion electronic device of 801 comprises one of a plurality of companion electronic devices operating within the environment of the electronic device. At 805, the method of 804 further comprises determining, by the one or more processors, a location of each companion electronic device of the plurality of companion electronic devices within the environment relative to the electronic device.

At 806, the determining of 805 occurs using one of an ultra-wide band ranging process or a Bluetooth channel sounding process. At 807, the method of 805 further comprises correlating a direction of movement of the swipe gesture across the user interface with locations of the plurality of companion electronic devices to identify the companion electronic device identified by the swipe gesture. At 808, the determining of 807 occurs prior to the receiving.

At 809, the transferring of 801 occurs only when the swipe gesture is received while the electronic device is in an unlocked condition. At 810, the application operating on the one or more processors of 801 comprises a foreground application operating on an application stack. At 810, the method further comprises surfacing a penultimate application of the application stack on the user interface as a new foreground application after the transferring.

At 811, the method of 801 further comprises also receiving, by the user interface after the transferring, a predefined gesture. At 811, the method comprises recalling, by the one or more processors using the communication device in response to the predefined gesture, the operation of the application from the companion electronic device. At 811, the method comprises resuming, by the one or more processors, the operation of the application on the one or more processors of the electronic device.

At 812, the predefined gesture of 811 comprises one of a tap gesture or a double-tap gesture. At 813, the companion electronic device of 811 comprises one of a plurality of companion electronic devices operating within the environment of the electronic device. At 813, the predefined gesture identifies the companion electronic device from which the operation of the application should be withdrawn.

At 814, an electronic device comprises a user interface, a communication device, and one or more processors operable with the user interface and communication device. At 814, the one or more processors, in response to the user interface receiving a swipe gesture across a surface of the user interface defining a directional vector identifying a companion electronic device operating in an environment of the electronic device, cause the communication device to transfer operation of a foreground application operating on the one or more processors to the companion electronic device identified by the swipe gesture.

At 815, the one or more processors of 814 further cause the communication device to recall the operation of the foreground application from the companion electronic device in response to the user interface receiving another gesture input. At 816, the other gesture input of 815 comprises a reverse swipe gesture defining a reverse directional vector identifying the companion electronic device. At 817, the one or more processors of 814 cause an animation of a graphical user interface of the foreground application to move on the user interface along the directional vector while the communication device transfers the operation of the foreground application operating on the one or more processors to the companion electronic device identified by the swipe gesture.

At 818, a method in an electronic device comprises receiving, by a user interface, a swipe gesture defining a directional vector extending from the electronic device to a companion electronic device operating in an environment of the electronic device. At 818, in response to the swipe gesture, the method comprises causing, by one or more processors using a communication device, operation of a foreground application of an application stack to be transferred to the companion electronic device identified by the directional vector. At 818, the method comprises surfacing, by the one or more processors, operation of a penultimate application of the application stack as a new foreground application after the causing.

At 819, the companion electronic device of 818 comprises one of a plurality of companion electronic devices operating within the environment of the electronic device. At 820. The method of 818 further comprises animating, by the one or more processors, movement of a graphical user interface of the foreground application out of the application stack during the causing.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by a user interface, a swipe gesture identifying a companion electronic device operating within an environment of the electronic device; and
transferring, by one or more processors using a communication device in response to the swipe gesture, operation of an application operating on the one or more processors to the companion electronic device identified by the swipe gesture.

2. The method of claim 1, wherein the swipe gesture identifies the companion electronic device when a swipe direction of motion across the user interface occurs in a direction toward the companion electronic device.

3. The method of claim 1, wherein the swipe gesture identifies the companion electronic device when a swipe direction of motion across the user interface defines a directional vector extending from the electronic device to the companion electronic device.

4. The method of claim 1, wherein the companion electronic device comprises one of a plurality of companion electronic devices operating within the environment of the electronic device.

5. The method of claim 4, further comprising determining, by the one or more processors, a location of each companion electronic device of the plurality of companion electronic devices within the environment relative to the electronic device.

6. The method of claim 5, wherein the determining occurs using one of an ultra-wide band ranging process or a Bluetooth channel sounding process.

7. The method of claim 5, further comprising correlating a direction of movement of the swipe gesture across the user interface with locations of the plurality of companion electronic devices to identify the companion electronic device identified by the swipe gesture.

8. The method of claim 7, wherein the determining occurs prior to the receiving.

9. The method of claim 1, wherein the transferring occurs only when the swipe gesture is received while the electronic device is in an unlocked condition.

10. The method of claim 1, wherein the application operating on the one or more processors comprises a foreground application operating on an application stack, further comprising surfacing a penultimate application of the application stack on the user interface as a new foreground application after the transferring.

11. The method of claim 1, further comprising:
also receiving, by the user interface after the transferring, a predefined gesture;
recalling, by the one or more processors using the communication device in response to the predefined gesture, the operation of the application from the companion electronic device; and
resuming, by the one or more processors, the operation of the application on the one or more processors of the electronic device.

12. The method of claim 11, wherein the predefined gesture comprises one of a tap gesture or a double-tap gesture.

13. The method of claim 11, wherein:
the companion electronic device comprises one of a plurality of companion electronic devices operating within the environment of the electronic device; and
the predefined gesture identifies the companion electronic device from which the operation of the application should be withdrawn.

14. An electronic device, comprising:
a user interface;
a communication device; and
one or more processors operable with the user interface and communication device;
wherein the one or more processors, in response to the user interface receiving a swipe gesture across a surface of the user interface defining a directional vector identifying a companion electronic device operating in an environment of the electronic device, cause the communication device to transfer operation of a foreground application operating on the one or more processors to the companion electronic device identified by the swipe gesture.

15. The electronic device of claim 14, wherein the one or more processors further cause the communication device to recall the operation of the foreground application from the companion electronic device in response to the user interface receiving another gesture input.

16. The electronic device of claim 15, wherein the another gesture input comprises a reverse swipe gesture defining a reverse directional vector identifying the companion electronic device.

17. The electronic device of claim 14, wherein the one or more processors cause an animation of a graphical user interface of the foreground application to move on the user interface along the directional vector while the communication device transfers the operation of the foreground application operating on the one or more processors to the companion electronic device identified by the swipe gesture.

18. A method in an electronic device, the method comprising:
receiving, by a user interface, a swipe gesture defining a directional vector extending from the electronic device to a companion electronic device operating in an environment of the electronic device;
in response to the swipe gesture causing, by one or more processors using a communication device, operation of a foreground application of an application stack to be transferred to the companion electronic device identified by the directional vector; and
surfacing, by the one or more processors, operation of a penultimate application of the application stack as a new foreground application after the causing.

19. The method of claim 18, wherein the companion electronic device comprises one of a plurality of companion electronic devices operating within the environment of the electronic device.

20. The method of claim 18, further comprising animating, by the one or more processors, movement of a graphical user interface of the foreground application out of the application stack during the causing.
